(19) United States
(12) Patent Application Publication
(10) Pub. No.: US 2003/0135373 A1
(43) Pub. Date: Jul. 17, 2003

(54) Method for generating vocal prompts and system using said method

(75) Inventors: Frank Diebolt, Illkirch (FR); Cedric Simon, Illkirch (FR); Sebastien Villars, Illkirch (FR)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/326,615

(22) Filed: Dec. 23, 2002

(30) Foreign Application Priority Data
Jan. 11, 2002 (EP) 02 360 021.6

(51) Int. Cl. G10L 13/08

(52) U.S. Cl. 704/260

(57) ABSTRACT

The present invention concerns a method for generating vocal prompts or similar audio messages in relation with a text to speech process or engine in a multitasking environment. Some vocal messages or prompts are imported and/or generated by said TTS process or engine and stored in a cache in an available state, to be rendered or reproduced upon adequate request without using said TTS process or engine.

### TECHNICAL FIELD

The present invention relates generally to the generation of audio or voice messages based on text data, in particular in connection with Text to Speech (TTS) means, and concerns a method for generating vocal prompts or similar audio message, and a unified voice mail system making use of said method. The invention is based on a priority application EP 02 360 021.6 which is hereby incorporated by reference.

### BACKGROUND OF THE INVENTION

It is known that using TTS engines considerably reduces the application development costs and the localising tasks. In fact, in a TTS based application, texts to speak are composed very easily, whereas in non-TTS applications, prompts have to be recorded by voice talents and the developers have to be cautious with prompt transitions. The voice talent is the TTS engine for which the customers pay a license. The localisation consists in translating the strings and buying the TTS engine for the new language.

Nowadays, TTS based applications are limited because of their very heavy resource needs, as all TTS engines or processes are very time consuming tasks, therefore reducing available CPU resources of the PC or server which might be needed for other real time tasks.

The impact of the aforementioned drawback is even substantially increased when a multilingual TTS engine is implemented and/or when a great number of users have to be served simultaneously.

A proposed solution in order to try to overcome the aforementioned problem consists in using several TTS engines distributed on several servers. Those servers are often grouped as a cluster, and a load balancing mechanism is implemented to distribute TTS rendering requests among all the servers.

Nevertheless, this known solution implies that customers buy several servers, and if their use of TTS increases, they will have to add more servers in the cluster.

Furthermore, in the particular case of a unified voice mail system, most of the prompts are static and known at design time (in previous versions of unified messaging systems or voice mail systems, prompts were recorded by “voice talent”). The only dynamic prompts in voice mail systems are generally limited to users' emails. It can therefore be considered that it is too costly to use several TTS servers to generate and play static prompts.

Thus, the problem to be solved by the invention is to reduce the need in resources and in dedicated servers in the foregoing context, and especially to allow more users to run TTS based applications on a single machine or on a limited number of servers, without slowing down the other performed tasks by a substantial amount.

### SUMMARY OF THE INVENTION

Therefore, the present invention mainly concerns a method for generating vocal prompts or similar audio messages in relation with a text to speech process or engine in a multitasking environment, characterised in that some vocal messages or prompts are imported and/or generated by said TTS process or engine and stored in a cache in an available state, to be rendered or reproduced upon adequate request without using said TTS process or engine.

According to a feature of the invention, each stored prompt is identified by an indicator of its textual content, said indicator being advantageously a signature. Such signature being a digital signature which identifies and authenticates the message data (MD) using an one-way hash or message digest function. Latter is based on some public-key digital signature system. Rather than sign a long message, which can take a long time, it has the advantage to compute the one-way hash of the message, and sign the hash. Preferably a MD5 type signature is used, calculated using the prompt text.

In its current implementation, the method comprises, each time some requested prompt text has to be rendered, the operating steps:

calculating the signature(s) of said text,

comparing said signature(s) with the signatures of the vocal prompts stored in the cache and retrieving, and,

retrieving the audio content(s) of the concerned stored prompt(s) if the compared signatures match, without making use of the TTS process or engine.

In case of a long or complex prompt text, the operating steps are performed for each (previously recognised) segment or part of said text.

According to a most preferred additional feature of the invention, the method further consists in performing the audio rendering, by said TTS process or engine, of each prompt text or text segment which is not stored in the cache, transmitting it to the audio reproducing or playing means and storing a copy of said audio rendering or equivalent in the cache with an adequate labelling. Thus, the cache will be filled progressively with supplementary contents of various prompts or prompt parts and consequently the TTS engine will therefore be less and less used as time passes.

In order to have the method operative as quickly as possible with a good efficiency, one can think of importing and/or generating at least some static vocal prompts at once at an earlier stage, such as an installation or initialisation phase, and storing the audio contents of said prompts in a cache by labelling them in relation with their textual content.

As can be noticed from the foregoing, the basic idea of the invention is to import or to let the TTS engine generate static prompts once and to implement a cache mechanism in which prompts are identified by their textual content, using a MD5 signature based on the prompt text. Before asking the TTS engine to render a text, the MD5 signature of this text is calculated. Then this signature is looked up in the cache in order to find the previously rendered vocal version of the corresponding text if available. If said vocal version is not stored in the cache, it will be produced by the TTS engine and a copy of it stored in the cache with its signature.

The present invention also concerns a unified voice mail system using or able to implement the method described before and comprising a text to speech (TTS) engine.

Said system is characterised in that it also comprises a cache memory for storing the audio contents of prompts or parts of prompts, computing means for calculating an indicator for each prompt or prompt part to be stored and comparator means for comparing two indicators.

Preferably, the indicator is a MD5 type signature of the text of the concerned prompt or prompt part and the method can also comprise segment recognition and/or segmentation means, treating the texts of the prompts to be rendered before calculation of their corresponding indicator(s).

Said system will in practice also comprise a voice browser receiving prompts or part of prompts in audio form from the TTS engine and/or the cache memory and transmitting them to audio playing means, possibly after putting them in the correct order.

### DETAILED DESCRIPTION OF PREFERRED EMBODIMENTS

This invention will be better understood thanks to the following description explaining a preferred embodiment of the invention as a non limitative example.

To show a practical implementation of the invention, one can consider a voice browser which is an application that reads VoiceXML files and generate an output over a phone set.

Such a unified voice mail system in VoiceXML is for example described in W3C Note 05 of May 2000 (URL address: http//www.w3.org/TR/Voicexml).

VoiceXML is an XML based conversation description language consisting in an XML tag hierarchy (VoiceXML is specified by the W3C organisation) such as “<form>, <block>, <menu>, <prompt>”, etc. The <prompt> tag is used to define a text to be rendered by TTS and played on a phone set.

When the voice browser parses a VoiceXML file, each text segment of a prompt section is looked up in the cache by using its MD5 signature.

If the text has already been vocaly rendered by the TTS engine, the voice browser will retrieve directly the audio content from the cache and play it (without any work for the TTS engine).

If the vocal version of this text is not stored in the cache, then the TTS engine performs the vocal rendering of this text, transmits it to the voice browser and puts a copy in the cache for future playings.

The cache may be pre-filled during the installation of the product with most of the static prompts needed by the unified messaging system.

Each customer has a specific use of their Unified messaging system. It means that some static prompts may be missing in the cache. Those prompts will be generated progressively when they are needed and put in the cache. So, the cache will be filled progressively. The mechanism according to the invention will “learn” the specificities of each customer at run time.

If another application that needs the TTS is plugged, its dedicated static prompts may be provided or the cache may be filled automatically (knowing in this case that the first use of the TTS related application will be slower).

The present invention is, of course, not limited to the preferred embodiments described herein, changes can be made or equivalents used without departing from the scope of the invention.

1. Method for generating vocal prompts or similar audio messages in relation with a text to speech process or engine in a multitasking environment, wherein some vocal messages or prompts are imported and/or generated by said TTS process or engine and stored in a cache in an available state, to be rendered or reproduced upon adequate request without using said TTS process or engine, while each stored prompt is identified by an indicator of its textual content, said indicator being a signature, preferably a MD5 type signature, calculated using the prompt text.

2. Method according to claim 1, wherein it consists in importing and/or generating at least some static vocal prompts at once at an earlier stage, such as an installation or initialisation phase, and storing the audio contents of said prompts in a cache by labelling them in relation with their textual content.

3. Method according to claim 1 or 2, wherein it comprises, each time some requested prompt text has to be rendered, the operating steps of calculating the signature(s) of said text, comparing said signature(s) with the signatures of the vocal prompts stored in the cache and retrieving and rendering the audio content(s) of the concerned stored prompt(s) if the compared signatures match, without making use of the TTS process or engine.

4. Method according to claim 3, wherein, in case of a long or complex prompt text, the operating steps are performed for each segment or part of said text.

5. Method according to anyone of claims 3 or 4, wherein it further consists in performing the audio rendering, by said TTS process or engine, of each prompt text or text segment which is not stored in the cache, transmitting it to the audio reproducing or playing means and storing a copy of said audio rendering in the cache with an adequate labelling.

6. Unified voice mail system using the method according to anyone of claims 1 to 5, comprising a text to speech engine, wherein it also comprises a cache memory for storing the audio contents of prompts or parts of prompts, computing means for calculating an indicator for each prompt or prompt part to be stored and comparator means for comparing two indicators.

7. System according to claim 6, wherein each indicator is a MD5 type signature of the text of the concerned prompt or prompt part.

8. System according to anyone of claims 6 and 7, wherein it also comprises segment recognition and/or segmentation means, treating the texts of the prompts to be rendered before calculation of their corresponding indicator(s).

9. System according to anyone of claims 6 to 8, wherein it also comprises a voice browser receiving prompts or part of prompts in audio form from the TTS engine and/or the cache memory and transmitting them to audio playing means, possibly after putting them in the correct order.
